(19) United States
(12) Patent Application Publication
(10) Pub. No.: US 2016/0334232 A1
(43) Pub. Date: Nov. 17, 2016

(54) REAL-TIME CARPOOLING

(71) Applicant: General Motors, LLC, Detroit, MI (US)

(72) Inventor: Yue Zhuang, Southfield, MI (US)

(21) Appl. No.: 14/709,059

(22) Filed: May 11, 2015

(51) Int. Cl. G01C 21/34; G06Q 10/02

(52) U.S. Cl. CPC G01C 21/3438; G06Q 10/02

(57) ABSTRACT

A carpooling server includes a processor; a server communication transceiver that receives pick-up time and location, drop-off location, and window time from a mobile device communication platform, and delay threshold from a participating vehicle (PV) communication platform; and a real-time carpooling program. First filter includes computer readable instructions (CRI) to identify a qualified trip upon determining pick-up time is within a PV trip travel period. Second filter receives a then-current location of the PV associated with the qualified trip, and includes CRI to: estimate an arrival time (ETA) of PV at pick-up location; and identify a potential carpool candidate (PCC) upon determining ETA is within the window time. Third filter includes CRI to: estimate a new end time (ENET) for the PCC by combining the PV then-current location with pick-up/drop-off locations and an original PV destination; and identify a carpool candidate upon determining ENET is within the delay threshold.

### TECHNICAL FIELD

The present disclosure relates generally to real-time carpooling.

### BACKGROUND

Carpooling, also known as car-sharing, ride-sharing, etc., involves the sharing of a car ride, so that more than one person travels in the vehicle. Carpooling has been used by people for a variety of reasons, such as reducing each person's travel costs (e.g., fuel cost, tolls, etc.) and reducing the number of vehicles on the road (thus reducing traffic and potentially opening up parking spaces at particular destinations). When carpooling is used for commuting to and from work, it may also reduce the number of times a particular individual actually has to drive the route.

### SUMMARY

Real-time carpooling systems are disclosed herein. An example of the real-time carpooling system includes a mobile device, a participating vehicle, and a carpooling server. The mobile device includes a microprocessor and a mobile device communication platform. The participating vehicle includes a microprocessor and a vehicle communication platform. The carpooling server includes a processor; a server communication transceiver that receives 1) a requester pick-up time and location, a requester drop-off location, and a window time from the mobile device communication platform, and 2) a delay threshold from the vehicle communication platform; and a real-time carpooling program embedded on a non-transitory, tangible computer readable medium and executable by the processor.

The real-time carpooling program includes first, second, and third filters. The first filter includes computer readable instructions to identify a qualified trip in response to determining that the requester pick-up time is within a trip travel period of a participating vehicle. The second filter receives a then-current location of the participating vehicle associated with the qualified trip, and includes computer readable instructions to: estimate an arrival time of the participating vehicle at the requester pick-up location; and identify a potential carpool candidate in response to determining that the estimated arrival time is within a window time of a requester. The third filter includes computer readable instructions to: estimate a new end time for the potential carpool candidate by combining the then-current location of the participating vehicle with the requester pick-up location, the requester drop-off location, and an original destination of the participating vehicle; and identify a carpool candidate in response to determining that the estimated new end time is within a delay threshold of the participating vehicle.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic view of an example of a real-time carpooling system; and

FIG. 2 is a flow diagram illustrating an example of a method for making real-time carpool arrangements.

### DETAILED DESCRIPTION

The real-time carpooling system disclosed herein includes a plurality of participating vehicles and drivers. In some examples, when a particular driver is able to actively participate in carpooling, he/she may utilize a vehicle communications platform to inform a carpooling server that the vehicle then-currently has an active carpooling status. The carpooling server keeps a record, in real-time, of the participating vehicle(s) having the active carpooling status. The carpooling server is also able to obtain other real-time information in an attempt to match the participating vehicle(s) having the active carpooling status with a requesting rider (i.e., requester). The carpooling server does not continuously monitor the participating vehicle(s) as it travels its route, and does not store the real-time location of the participating vehicle(s). Rather, to identify which participating vehicle(s) (with the active carpooling status) would be a suitable carpool host for the requester, a processor of the carpooling server executes a real-time carpooling program. The real-time carpooling program includes three customizable filters, one of which is capable of identifying qualified trip(s), another of which is capable of narrowing the qualified trip(s) to potential carpool candidate(s), and still another of which is capable of narrowing the potential carpool candidate(s) to carpool candidate(s).

In the examples disclosed herein, the “participating vehicle” refers to a vehicle that is enrolled in a carpooling service. The enrolled vehicle is linked to the vehicle owner and/or any number of pre-authorized carpooling drivers. It is to be understood that a vehicle owner or operator who wishes to participate in the carpooling service may sign up or enroll through a center that operates the carpooling service (e.g., via a web page, by calling an advisor at the center, etc.). Upon signing up, a profile may be generated for the user and/or vehicle and stored at the center. Alternatively, if the center already maintains the user and/or vehicle profile when the user enrolls, this profile may be accessed and updated to reflect the involvement in the carpooling service.

The profile may include a list of vehicle(s) that are participating vehicles, a list of authorized carpooling driver(s), a number of seats that are typically available in the vehicle(s) for carpool rider(s), any amenities or information that the driver wishes to offer to carpool rider(s) (e.g., air conditioning, etc.), and/or combinations thereof. Within the profile, the participating vehicle(s) may be identified through the vehicle identification number or a carpooling identification number assigned thereto.

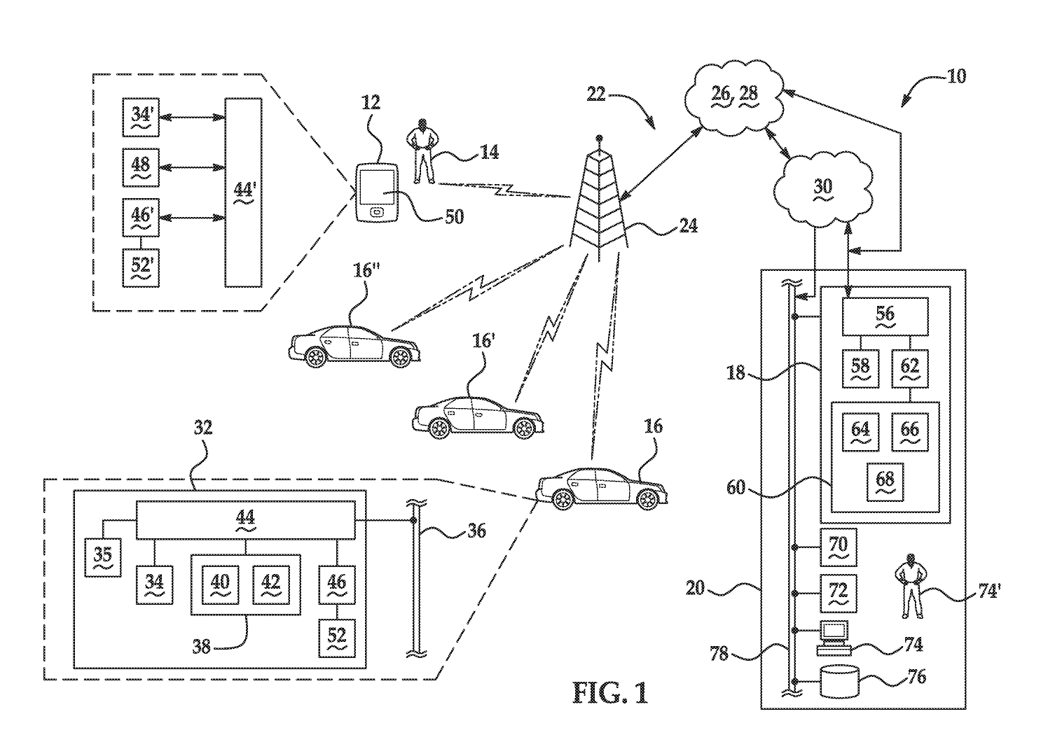

Referring now to FIG. 1, an example of the real-time carpooling system 10 is depicted. The system 10 includes a mobile device 12 of the requester 14, the plurality of participating vehicles 16, 16′, 16″, the carpooling server 18 (which may be part of a center 20 that provides back-end services to the participating vehicles 16, 16′, 16″ and operates the carpooling service), and a carrier/communication system 22.

Phone calls and/or messages (e.g., active carpooling status message, etc.) may be transmitted to, from, and/or between communication component(s) of the vehicle(s) 16, 16′, 16″, the mobile device 12, and/or the center 20 using the carrier/communication system 22. Some of the communication links between the various components are shown as lightning bolts and arrows in FIG. 1.

In an example, the carrier/communication system 22 is a two-way radio frequency (RF) communication system. The carrier/communication system 22 may include one or more cell towers 24 or satellites (not shown). It is to be understood that the carrier/communication system 22 may also include one or more base stations and/or mobile switching centers (MSCs) 26 (e.g., for a 2G/3G network), one or more evolved Node Bs (eNodeB) and evolved packet cores (EPC) 28 (for a 4G (LTE) network), and/or one or more land networks 30. The carrier/communication system 22 may be part of a cellular radio environment or a satellite radio environment, which may include a variety of wireless network providers (which include mobile network operator(s), not shown), utilizing the same or a variety of radio access technologies. While several examples have been provided, it is to be understood that the architecture of the wireless carrier/communication system 22 may be GSM (global system for mobile telecommunications), CDMA2000, UMTS (universal mobile telecommunications system), LTE (long-term evolution), or some other available architecture.

An Internet connection may also be utilized for the transmission of the message(s), data, etc. The transmission of the messages, data, etc. may be made using the carrier/communication system 22, either through the vehicle's Internet connection (e.g., when the vehicle 16, 16′, 16″ is equipped with a 4G long-term evolution, LTE, or other suitable Internet connection) or through the mobile device's cellular and Internet connection.

The vehicles 16, 16′, 16″ participating in the carpooling service may be a car, motorcycle, truck, or recreational vehicle (RV) that is capable of accommodating at least one passenger in addition to the driver. The vehicles 16, 16′, 16″ are equipped with suitable hardware and computer readable instructions/code that enable it to communicate (e.g., transmit and/or receive voice and data communications) over the carrier/communication system 22 (e.g., with the carpooling server 18). In some instances, the vehicle(s) 16, 16′, 16″ are also capable of communicating using a short range wireless communication link. The components of vehicle 16 will be described in more detail, although it is to be understood that each of the other vehicles 16′, 16″ may be equipped with the same or similar components.

As shown in FIG. 1, the vehicle 16 includes a vehicle communication/communications platform (VCP) 32. In an example, the VCP 32 is an on-board vehicle dedicated communications and entertainment device. In another example (not shown), the VCP 32 is an on-board vehicle dedicated communications device (e.g., a telematics unit), and the vehicle 16 includes a separate on-board vehicle dedicated entertainment device (e.g., an infotainment unit). Whether integrated into a single unit (e.g., VCP 32) or included as separate units, the on-board vehicle dedicated communications and entertainment device(s) include hardware components that are capable of running computer readable instructions/code, which are embodied on non-transitory, tangible computer readable media.

The VCP 32 may provide a variety of services, both individually and through its communication with the center 20 (e.g., which may be a facility that is owned and operated by an in-vehicle infotainment unit service provider). Several examples of these services include, but are not limited to: the carpooling service disclosed herein, turn-by-turn directions and other navigation-related services provided in conjunction with a location detection module 34; airbag deployment notification and other emergency or roadside assistance-related services provided in connection with various sensor interface modules and sensors located throughout the vehicle 16; and infotainment-related services where music, Web pages, movies, television programs, videogames and/or other content is downloaded by the VCP 32 via a vehicle bus system 36 and an audio bus system (not shown). The listed services are by no means an exhaustive list of all the capabilities of the VCP 32, but are simply an illustration of some of the services that the VCP 32 is capable of offering.

As noted above, the VCP 32 may be used for vehicle communications. Some vehicle communications (e.g., between the vehicle 16 and the carpooling server 18 at the center 20) utilize radio or satellite transmissions to establish a voice channel with the carrier/communication system 22 such that both voice and data transmissions may be sent and received over the voice channel. In some instances, vehicle communications are enabled through the VCP 32 via a communications module 38, which includes a cellular chipset/component 40 for voice communications and a data transmission system 42 for data transmission.

The cellular chipset/component 40 of the VCP 32 may be an analog, digital, dual-mode, dual-band, multi-mode and/or multi-band wireless transceiver. The cellular chipset-component 40 uses one or more prescribed frequencies in standard analog and/or digital bands in the current market for cellular systems. Any suitable protocol may be used, including digital transmission technologies, such as TDMA (time division multiple access), CDMA (code division multiple access), W-CDMA (wideband CDMA), FDMA (frequency-division multiple access), OFDMA (orthogonal frequency-division multiple access), etc.

In an example, the data transmission system 42 may include a packet builder, which is programmed to make decisions about what packet to send (e.g., bandwidth, data to include, etc.) and to actually build a packet data message. In another example, the data transmission system 42 may include a wireless modem, which applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. While examples have been provided, it is to be understood that any suitable data transmission system 42 may be used.

The VCP 32 may also be configured for short range wireless communication technologies, such as BLUETOOTH® and various classes thereof, dedicated short-range communications (DSRC), or WI-FI™ and various classes thereof.

The location detection unit 34 may include a GPS receiver, a radio triangulation system, a dead reckoning position system, and/or combinations thereof. In particular, a GPS receiver provides accurate time and latitude and longitude coordinates of the vehicle 16 responsive to a GPS broadcast signal received from a GPS satellite constellation (not shown). The location detection unit 34 may also include, for example, Glonass (i.e., global navigation satellite system), Sbas (i.e., satellite-based augmentation systems), or a D-GPS (differential global positioning system). The location detection chipset/component 34 may or may not be part of an in-vehicle navigation unit.

The VCP 32 may also include a real-time clock (RTC) 35. The real-time clock (RTC) 35 provides accurate date and time information to the VCP 32 hardware and software components that may require and/or request date and time information. In an example, the RTC 35 may provide time and/or date information for the start of a trip.

The VCP 32 also includes an electronic processing device 44 operatively coupled to one or more types of electronic memory 46. In an example, the electronic processing device 44 is a microprocessor. In other examples, the electronic processing device 44 may be a micro controller, a controller, and/or a host processor. In another example, electronic processing device 44 may be an application specific integrated circuit (ASIC). The electronic memory 46 of the VCP 32 may be an encrypted memory that is configured to store i) computer readable instructions/code to be executed by the processor 44, ii) data associated with the various systems of the vehicle 16 (i.e., vehicle data, VIN, carpooling identification number, etc.), and the like. The electronic memory 46 may be a non-transitory, tangible computer readable media (e.g., RAM).

In the examples disclosed herein, when the owner or operator of the vehicle 16 wants to actively participate in carpooling, he/she may utilize the VCP 32 to inform the carpooling server 18 that the vehicle 16 is available for ride sharing. In an example, the owner or operator may utilize an in-vehicle application 52 (stored on memory 46) to transmit a carpool status message to the carpooling server 18. The carpool status message may indicate that the vehicle carpool status should be marked as active. In still another example, each time a user starts the vehicle 16, the in-vehicle application 52 may inquire (e.g., through an in-vehicle display) as to whether the user would like the carpool status to be set to active. If the in-vehicle application 52 receives a positive input in response to the inquiry, the carpool status message may be sent from the in-vehicle application 52 to the carpooling server 18.

In still another example, the owner or operator may pre-set his/her carpooling schedule, and this pre-set schedule may be saved at the carpooling server 18. The carpooling server 18 then automatically sets the active status of the vehicle 16 according to the pre-set schedule. In yet a further example, the vehicle 16 (e.g., through obtained vehicle data, including location data from the location detection module 34) learns the driving behaviors or patterns of the owner or operator. Upon recognizing that the vehicle has a routine driving behavior or pattern, the in-vehicle application 52 may display a query to inquire as to whether the vehicle owner or operator wants to set this as a pre-set carpooling schedule. In response to a positive input, the carpooling server 18 will save the time(s) associated with the routine driving behavior or pattern as the pre-set schedule, and will then automatically set the active status of the vehicle 16 according to the pre-set schedule.

When informing the carpooling server 18 that the vehicle 16 is available for ride sharing, the owner or operator of the vehicle 16 may also input trip information and/or the in-vehicle application 52 may collect trip information. If the carpooling server 18 is generating the active status from the pre-set schedule, the trip information will already be saved at the carpooling server. The trip information may include the trip starting time and location, the trip ending location (i.e., destination), and a threshold delay associated with the trip. As used herein, the “delay threshold” refers to a maximum amount of additional time that may be added to the then-current trip period (e.g., as a result of picking up a carpool rider) that would be acceptable to the vehicle owner or operator making the trip. The delay threshold may vary depending upon the tolerance, schedule, etc. of the vehicle owner or operator. When setting the delay threshold, the vehicle owner or operator may take into consideration external factors, such as weather, traffic, etc. In an example, the delay threshold may range from about 5 minutes to about 45 minutes. As specific examples, in a rural area, the delay threshold may range from about 15 minutes to about 20 minutes, and in an urban area, the delay threshold may range from about 30 minutes to about 45 minutes.

The in-vehicle application 52 may have a graphical user interface that enables the vehicle owner or operator to manually input the ending location and the threshold delay. For example, the in-vehicle application 52 may include input boxes to receive the ending location (e.g., a point of interest, an address, an intersection, latitude and longitude coordinates, or other suitable location information), or drop down menus for the owner or operator to select the ending location. The in-vehicle application 52 may also include input boxes and/or drop down menus for the vehicle owner or operator to input his/her threshold delay.

The in-vehicle application 52 may be in communication with the location detection module 34 to receive the starting location for the vehicle's trip and with the real time clock to receive the starting time for the vehicle's trip. This trip information may be transmitted to the carpooling server 18 in the carpool status message.

In addition to including the indication that the vehicle 16 should be associated with the active carpooling status and the trip information, the active carpooling message (or active message regarding carpooling) may also include a header, which identifies the vehicle 16 from which the carpool status message is being sent. The header may include the vehicle's mobile dialing number, vehicle identification number, VCP serial number, carpooling identification number, etc. This enables the carpooling server 18 to associate the active status and trip information with the correct vehicle 16. The carpooling server 18 will be described in more detail below.

The system 10 also includes the mobile device 12. The mobile device 12 may be a smart phone, such as a GSM/LTE phone or a GSM/CDMA/LTE phone. In other examples, the mobile device 12 may be any portable device that has a mobile device communication platform 48, a location detection module 34′, a display 50, a microprocessor 44′, and an electronic memory 46′. Examples of other mobile devices 12 include a wearable device (e.g., foot pod, smart bracelet, smart watch, helmet, etc.), tablet, key fob, etc., each of which may be, for example, GPS, cellular/Internet wireless communication enabled, and/or short range wireless communication enabled. The short range wireless communication capability (e.g., BLUETOOTH® and variations thereof) enables the mobile device 12 to communicate with other mobile devices via short range communication technologies.

The wireless communication platform 48 may include a cellular chipset/component for voice communications, a data transmission unit for data transmission, and a short range wireless communication unit for short range wireless communications. In these examples, the mobile device 12 is capable of making cellular or satellite connections and/or Internet connections (over the wireless carrier/communication system 22).

The location detection module 34′ of the mobile device 12 may be similar to the location detection module 34 of the vehicle 16.

The mobile device 12 includes physical hardware (e.g., the microprocessor 44′) and computer readable instructions stored in the electronic memory 46′. The microprocessor 44′ of the mobile device 12 may be similar to microprocessor 44 of the vehicle 16, and is capable of executing the computer readable instructions stored in the memory 46′, which may be similar to the electronic memory 46. The electronic memory 46′ stores thereon a mobile device application 52′.

The mobile device application 52′ may be downloaded (e.g., from an online application store or marketplace) and stored on the electronic memory 46′. The program 52′ may be opened by the user 14 using the display 50 of the mobile device 12. In an example, the display 50 is a full-color touch screen display. Other examples of the display 50 include a VFD (Vacuum Fluorescent Display), an LED (Light Emitting Diode) display, an LCD (Liquid Crystal Diode) display, and/or the like.

In another example, the mobile device application 52′ may be programmed to open automatically after identifying a pattern or routine behavior of the user 14 requesting a carpool. For example, the application 52′ may recognize that the user routinely requests a carpool ride to and from particular locations on Monday through Thursday at 8 am and again at 5 pm. This routine may be recognized by a timestamp of when the application 52′ is launched, as well as location detection module 34′ data of when the application 52′ is launched, as well as the input pick-up and drop-off locations. After learning the routine carpool request, the application 52′ may be programmed to launch itself.

The mobile device application 52′ includes a graphical user interface (GUI), which includes an input GUI and an output GUI. The input GUI allows the user 14 of the mobile device 12 to enter a carpooling request, and the output GUI presents, through the display 50, messages (e.g., “no carpool available” messages) or carpool candidate(s), which are private messages for the user's 14 selection alone.

The application 52′ may or may not require the user 14 to log in. Once opened, the input GUI of the application 52′ enables the user 14 to enter the request for a carpool ride. Throughout this discussion, the user 14 will also be referred to as the requester. The carpooling request includes at least a requester pick-up time, pick-up location, drop-off location, and window time. As used herein, the “window time” refers to a time frame that encompasses the maximum amount of time that the requester/user 14 is willing to wait for a carpool ride to arrive at the pick-up location after the requester pick-up time has passed. The window time may also include the earliest time that the requester 14 can be available before the pick-up time has occurred. The window time may vary depending upon the tolerance, schedule, etc. of the user 14. In an example, the window time may range from about 5 minutes to about 30 minutes.

The pick-up time and the window time may be entered manually by the user 14 or may be selected from a pop-up windows generated by the application 52′. In an example, the pop-up windows include a scrollable hour column and a scrollable minute column for the user to respectively input the pick-up time and the window time.

For the pick-up location, the application 52′ may inquire as to whether the user 14 wishes to use his/her current location. If the user 14 indicates that he/she does wish to use his/her current location, the application 52′ recognizes the then-current location of the mobile device 12 (through the location detection module 34′) and uses this location information for the pick-up location. Alternatively, the user can input an address, an intersection, or location coordinates as the pick-up location.

In one example, an address, an intersection, or location coordinates may be manually entered by the user 14 to identify the drop-off location. In another example, the user 14 may use a search feature/box presented by the input GUI of the application 52′ to search through a location database associated with or accessible by the location detection module 34′. When a search term is entered, the application 52′ instructs the location detection module 34′ to search for a location associated with the search term. The search results may be presented to the user 14 on the display 50, and the user 14 may select the drop-off location from the results presented.

Upon receiving the carpooling request (including the pick-up and drop-off information and the window time), the application 52′ transmits the carpooling request to the carpooling server 18 through the carrier/communication system 22. This carpooling request informs the carpooling server 18 that the requester 14 is looking for a ride.

The carpooling server 18 may be a dedicated server that participates in servicing carpool requests. The carpooling server 18 is a system of computer hardware and computer readable instructions that is capable of responding to carpooling requests received from the mobile device 12 by attempting to match the participating vehicle(s) 16, 16′, 16″ (having active status) with the requesting mobile device 12.

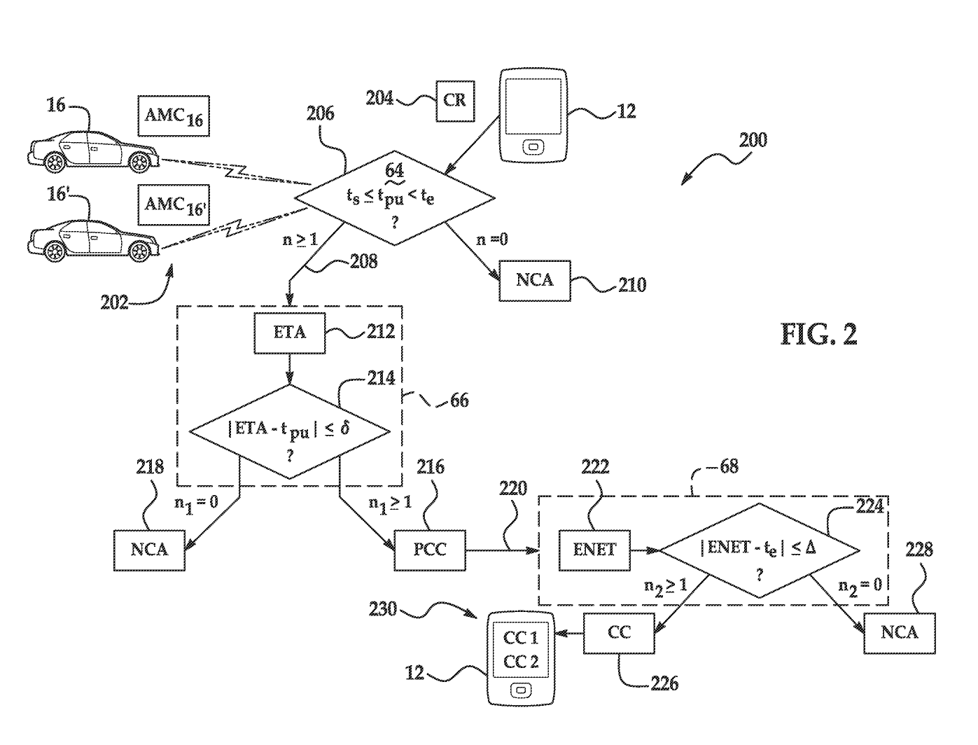

Both FIGS. 1 and 2 will be referenced in the description of the carpooling server 18. FIG. 2 illustrates a flow diagram of a method 200 for making real-time carpool arrangements.

As shown in FIG. 1, the carpooling server 18 includes a processor 56. The processor 56 may be a controller, a host processor, an ASIC, or a processor working in conjunction with a central processing unit (CPU). The processor 56 is capable of executing the computer readable instructions of a real-time carpooling program 60 stored on an electronic memory 62 of the carpooling server 18.

The carpooling server 18 also includes a server communication transceiver 58 that is in selective communication with both the VCP 32 and the mobile device communication platform 48. The server communication transceiver 58 may be any suitable data transmission system that is capable of sending and/or receiving data communications over the carrier/communication system 22. For example, the server communication transceiver 58 is capable of receiving the active carpooling message (including the trip information, e.g., the delay threshold) from the VCP 32 of the participating vehicle 16, as well as the carpooling request (including the pick-up time/location, the drop-off location, and the window time) from the mobile device communications platform 48. In FIG. 2, the transmission of respective active carpooling messages or active message re: carpooling AMC₁₆ and AMC_{16′} from the participating vehicles 16 and 16′ is shown at reference numeral 202 and the transmission of the carpooling request CR from mobile device 12 is shown at reference numeral 204.

As mentioned above, the carpooling server 18 also includes the real-time carpooling program 60 stored on its electronic memory 62. The real-time carpooling program 60 includes three customizable filters 64, 66, 68. The filters 64, 66, 68 are referred as customizable because the output they generate is customized based on the delay threshold of the participating vehicles 16, 16′, 16″ as well as the window time of the requester 14. As will be described in detail below, the real-time carpooling program 60 is executed by the processor 56 when the carpooling request CR is received by the carpooling server 18.

When the active carpooling message(s) AMC₁₆ and AMC_{16′} is/are received by the carpooling server 18, the carpooling server 18 locates the profile of the vehicle 16 and updates the carpooling status of the vehicle 16 to active. The carpooling server 18 keeps a record, in real-time, of the participating vehicle(s) 16, 16′, 16″ that have the active carpooling status. This record may include the information for each vehicle 16, including identification, starting time, starting and ending locations, and the delay threshold.

The ending time for the participating vehicle's trip may not be included in the active carpooling message(s) AMC₁₆ and AMC_{16′}. With the starting location, starting time, and the ending location, the program 60 of the carpooling server 18 may calculate the ending time, and thus determine the trip travel period, for any given vehicle 16, 16′, 16″. The carpooling server 18 may be programmed to calculate the ending time using a graph based street map. This map may be used by the filter(s) 64, 66, 68. If the received trip starting and ending locations are not in latitude and longitude coordinates, the carpooling server 18 converts the starting and ending locations to latitude and longitude coordinates. The nearest intersection ID to the starting location latitude and longitude and the nearest intersection ID to the ending latitude and longitude are then identified. The carpooling server 18 may be programmed to calculate, via Dijkstra's algorithm, the shortest path between the starting location nearest intersection ID and the ending location nearest intersection ID. The carpooling server 18 may be programmed to convert the shortest path to a series of intersection IDs. The carpooling server 18 may then determine the ending time of the vehicle's trip by dividing the length of the series of intersection IDSs by the average travel speed along the shortest path. The average travel speed may be the historical average speed for the shortest path, which may be determined using the speed limit, actual travel speeds, the weather conditions, traffic conditions for the time of day, etc. The trip ending time may be stored in the record, with the information for the given participating vehicle(s) 16, 16′, 16″.

The carpooling server 18 may also be programmed to convert any received times (e.g., starting time, delay threshold, etc.) to decimal time.

It is to be understood that the carpooling server 18 may update the record of active status participating vehicle(s) 16, 16′, 16″ continuously to ensure the pool of participating vehicles 16, 16′, 16″ with the active status is current. As an example, the carpooling server 18 may update the record in response to receiving new active carpooling message(s) AMC₁₆ and AMC_{16 ′}. Additionally, the carpooling server 18 may update the record in response to receiving a message indicating that a vehicle carpooling status should be changed to inactive (e.g., as prompted by an in-vehicle user or a vehicle off event).

When the carpooling request CR is/are received by the carpooling server 18 from the mobile device 12, the carpooling server 18 extracts the pick-up and drop-off information and the window time from the carpooling request CR. If the location information is not in latitude and longitude and/or the time information is not in decimal time, the carpooling server 18 is programmed to convert the data to these formats.

The carpooling server 18 then executes the real-time carpooling program 60 to attempt to find a carpool candidate to send to the mobile device 12.

The first filter 64 of the program 60 includes computer readable instructions to identify qualified carpool trip(s) from among the participating vehicle(s) 16, 16′, 16″ that have the active carpooling status. This is a first level for narrowing down the pool of active status participating vehicles 16, 16′, 16″ to a suitable carpool candidate. The first filter 64 compares the requester pick-up time (tᵤₚ)with the trip travel period (i.e., trip starting time, tₛ, and trip ending time, tₑ) for each of the participating vehicle(s) 16, 16′, 16″ that have the active carpooling status (shown at reference numeral 206 of FIG. 2). If the requester pick-up time is between the trip starting time and trip ending time (i.e., tₛ≦tᵤₚ≦tₑ) for a particular vehicle 16, the vehicle 16 is determined to be associated with a qualified carpool trip, and is filtered out from the pool of active status participating vehicles 16, 16′, 16″. The first filter 64 can identify n number of qualified carpool trips when the requester pick-up time is between the trip starting time and trip ending time (i.e., is within a trip travel period) of n number of the participating vehicles 16, 16′, 16″ (wherein n≧1). The qualified carpool trip(s) identified by the first filter 64 and the vehicle(s) associated therewith are sent to the second filter 66 for further narrowing down of the pool of active status participating vehicles 16, 16′, 16″ (shown at reference numeral 208 of FIG. 2).

However, if the requester pick-up time is outside the trip starting time and trip ending time (i.e., the trip travel period, e.g., tᵤₚ≦tₛ or tₑ≦tᵤₚ)of all of the active status participating vehicles 16, 16′, 16″ (i.e., n=0), then the first filter 64 runs computer readable instructions to generate a no carpool available message NCA (reference numeral 210 of FIG. 2). This message NCA is transmitted by the server communication transceiver 58 to the mobile device 12. This message NCA is received by the mobile device communications platform 48, which transmits it to the mobile device application 52′. The output graphical user interface of the mobile device application 52′ provides a visual representation of the message NCA on the display 50. This message NCA informs the requester 14 that no carpool is currently available that fits his/her request.

As mentioned above, when at least one qualified carpool trip is identified by the first filter 64, the n number of vehicle(s) associated with a qualified trip are transmitted to the second filter 66 (reference numeral 208 in FIG. 2). From the n number of vehicle(s) associated with a qualified trip, the second filter 66 attempts to identify potential carpool candidate(s). The second filter 66 provides a second level for narrowing down the pool of active status participating vehicles 16, 16′, 16″ to a suitable carpool candidate.

The second filter 66 includes computer readable instructions to estimate an arrival time (ETA) for each of the n number of participating vehicle(s) 16, 16′, 16″ at the requester pick-up location. In other words, the second filter 66 determines an estimated pick-up time. This is shown at reference numeral 212 of FIG. 2. To estimate the arrival time, the second filter 66 utilizes the requester pick-up location (received in the carpool request) and the then-current location of each of the n number of the participating vehicle(s) 16, 16′, 16″.

Since the carpooling server 18 does not continuously monitor the current position of the participating vehicle(s) 16, 16′, 16″ with active status, the carpooling server 18 dynamically determines the then-current location of each of the n number of the participating vehicle(s) 16, 16′, 16″ for the use by the second filter 66. To obtain the then-current location of the qualified trip participating vehicle(s) 16, 16′, 16″, the server communication transceiver 58 transmits a location request to the VCP 32 qualified trip participating vehicle(s) 16, 16′, 16″. The location detection unit 34, in combination with the VCP 32, of each vehicle 16, 16′, 16″, transmits the then-current location of the vehicle 16, 16′, 16″ back to the server communication transceiver 58 of the carpooling server 18.

The server communication transceiver 58 provides the second filter 66 with the then-current location information. The second filter 66 may be programmed to determine the nearest intersection ID for each of the requester pick-up location and the then-current location of the vehicle(s) 16, 16′, 16″. The second filter 66 may then calculate, via Dijkstra's algorithm, the shortest path between the requester pick-up location intersection ID and the then-current vehicle location nearest intersection ID. The second filter 66 may be programmed to convert this shortest path to a series of intersection IDs. The second filter 66 may then estimate the arrival time of the vehicle 16, 16′, 16″ (i.e., the estimated pick-up time, ETA) by dividing the length of this series of intersection IDs (i.e., the shortest path from the then-current location of the participating vehicle to the requester pick-up location) by the average travel speed along this shortest path.

The second filter 66 also includes computer readable instructions to identify a potential carpool candidate when the estimated arrival time of at least one (i.e., n₁) of the n number of participating vehicles 16, 16′, 16″ is within the window time of the requester 14 (i.e., n₁≧1). The second filter 66 is programmed to compare the difference between the estimated arrival time (ETA) and the requester pick-up time (|ETA−tᵤₚ|) with the requester's window time (δ) (shown at reference numeral 214 of FIG. 2). As such, the second filter 66 takes into account the tolerance of the requester 14. If the difference between the estimated arrival time (ETA) and the requester pick-up time (tᵤₚ)is less than or equal to the requester's window time (δ), the vehicle 16 is determined to be a potential carpool candidate PCC, and is filtered out from the pool of active status participating vehicles 16, 16′, 16″ associated with qualified trip(s) (shown at reference numeral 216 of FIG. 2). As an example, if the requester's window time is 10 minutes, the estimated arrival time ETA is 7:54 am, and the requester pick up time is 7:45 am, then the second filter 66 will determine that (|7:54 am-7:45 am|=9 minutes) and that 9 minutes <10 minutes, and that this ETA is within the window time of the requester 14.

However, if the estimated arrival time for all of the participating vehicles 16, 16′, 16″ is outside the window time of the requester 14, e.g., |ETA−tᵤₚ>δ, then n₁=0, and the second filter 66 runs computer readable instructions to generate a no carpool available message NCA (reference numeral 218 of FIG. 2). This message NCA is transmitted by the server communication transceiver 58 to the mobile device 12. This message NCA is received by the mobile device communications platform 48, which transmits it to the mobile device application 52′. The output graphical user interface of the mobile device application 52′ provides a visual representation of the message NCA on the display 50. This message NCA informs the requester 14 that no carpool is currently available that fits his/her request.

As mentioned above, when at least one potential carpool candidate PCC is identified by the second filter 66, the potential carpool candidate(s) PCC are transmitted to the third filter 68 (reference numeral 220 in FIG. 2). From the potential carpool candidate(s) PCC, the third filter 68 attempts to identify carpool candidate(s) CC. The third filter 68 provides a third level for narrowing down the pool of active status participating vehicles 16, 16′, 16″ to a suitable carpool candidate CC.

The third filter 68 is programmed to combine the requested trip of the requester 14 with the remaining trip of the potential carpool candidate(s) PCC to calculate an estimated new end/ending time (ENET) for the potential carpool candidate(s) PCC (reference numeral 222 of FIG. 2).

The third filter 68 utilizes the then current-location of the potential carpool candidate(s) PCC (i.e., the at least one (n₁) of the n number of participating vehicles 16, 16′, 16″ whose ETA is within the window time of the requester 14). To obtain the then-current location of the potential carpool candidate(s) PCC, the server communication transceiver 58 transmits a location request to the VCP 32 of each participating vehicle(s) 16, 16′, 16″ that has been identified as a potential carpool candidate(s) PCC. The location detection unit 34, in combination with the VCP 32, of each vehicle 16, 16′, 16″, transmits the then-current location of the vehicle 16, 16′, 16″ back to the server communication transceiver 58 of the carpooling server 18.

To estimate the new end/ending time (ENET) for the potential carpool candidate(s) PCC, the third filter 68 is programmed to combine the then-current location of the potential carpool candidate(s) PCC with the requester pick-up location, the requester drop-off location, and an original destination of the potential carpool candidate(s) PCC. The third filter 68 utilizes the graph based map and the intersection IDs to identify three shortest paths: a first shortest path from the then-current location of the potential carpool candidate(s) PCC to the requester pick-up location, a second shortest path from the requester pick-up location to the requester drop-off location, and a third shortest path from the requester drop-off location to the original destination of the participating vehicle. The third filter 68 is then programmed to calculate the shortest travel time along each of the first, second, and third shortest paths. To determine the shortest travel time along each path, the third filter 68 is programmed to divide a length of the respective shortest path by an average travel speed along the respective shortest path. For example, the first shortest travel time is determined by dividing a length of the first shortest path by the average travel speed along the first shortest path. The third filter 68 then adds the first shortest travel time, the second shortest travel time, and the third shortest travel time to a then-current time to determine the ENET. For example, if the first shortest travel time is 5 minutes, the second shortest travel time is 10 minutes, the third shortest travel time is 2 minutes, and the then-current time is 8:04 am, then the estimated new end time ENET for the particular potential carpool candidate PCC is 8:21 am.

The third filter 68 also includes computer readable instructions to identify at least one (n₂) carpool candidate CC when the estimated new end time ENET is within the delay threshold (Δ) of the at least one (n₁) of the n number of participating vehicles 16, 16′, 16″ (i.e., of the potential carpool candidate(s) PCC). The third filter 68 is programmed to compare the difference between the estimated new end time ENET and the trip ending time tₑ(|ENET−tₑ|) with the delay threshold Δ of the potential carpool candidate(s) PCC (shown at reference numeral 224 of FIG. 2). As such, the third filter 68 takes into account the tolerance of the vehicle owner or operator. If the difference between the estimated new end time ENET and the trip ending time tₑ is less than or equal to the owner or operator's delay threshold Δ, the vehicle 16 is determined to be a carpool candidate CC (i.e., n₂≧1), and is filtered out from the pool of potential participating carpool candidate(s) (shown at reference numeral 226 of FIG. 2). As an example, if the delay threshold Δ is 10 minutes, the ENET is 8:15 am, and the trip ending time tₑ is 8:07 am, then the third filter 68 will determine that (|8:15 am−8:07 am|=8 minutes) and that 8 minutes <10 minutes, and that this ENET is within the delay threshold Δ of the potential carpool candidate's owner or operator.

However, if the ENET for all of the participating vehicles 16, 16′, 16″ is outside the delay threshold Δ of the potential carpool candidate's owner or operator, e.g., |ENET−tₑ|>Δ, then n₂=0, and the third filter 68 runs computer readable instructions to generate a no carpool available message NCA (reference numeral 228 of FIG. 2). This message NCA is transmitted by the server communication transceiver 58 to the mobile device 12. This message NCA is received by the mobile device communications platform 48, which transmits it to the mobile device application 52′. The output graphical user interface of the mobile device application 52′ provides a visual representation of the message NCA on the display 50. This message NCA informs the requester 14 that no carpool is currently available that fits his/her request.

While not shown in FIG. 2, after the carpool candidate(s) CC are identified, the server communication transceiver 58 may transmit a message to each of the identified carpool candidate(s) CC. This message may provide the vehicle owner or operator with the estimated new end time ENET for his/her trip if he/she were to pick up the requester 14. The vehicle owner or operator may transmit a response back to the server communication transceiver 58 (using in-vehicle application 52) indicating whether or not he/she would like to be included as a carpool candidate sent to the requester 14. If the response is positive, the carpool candidate CC will be transmitted to the requester's mobile device 12. If the response is negative, the carpool candidate CC will not be transmitted to the requester's mobile device 12. It is to be understood that the carpool server 18 may be programmed to skip sending this message, in part because the filters 64, 66, 68 collectively take into account the delay threshold set by the owner or operator.

Referring back to FIG. 2, when at least one carpool candidate CC is identified by the third filter 68 (and in some instances approved by the vehicle owner or operator), the server communication transceiver 58 transmits the carpool candidate(s) CC to the mobile device 12. As shown at reference numeral 230 of FIG. 2, two carpool candidates CC1, CC2 have been identified by the program 60 and are transmitted to the mobile device communication platform 48 for visual representation on the display 50. The mobile device application 52′ presents the carpool candidates CC1, CC2 and enables the requester 14 to select one of the presented carpool candidates CC1 or CC2. The presentation may also include other details about the carpool candidate. For example, the details may include the type of vehicle, whether the vehicle has air conditioning, whether the driver provides a beverage, etc. The requester inputs his/her choice/selection, and this choice/selection is transmitted to the server communication transceiver 58 by the mobile device communication platform 48.

The carpooling server 18 includes a message function that is responsive to the requester carpool candidate choice/selection. The message function generates a message for the selected carpool candidate CC1 or CC2, indicating to the vehicle owner or operator that the vehicle 16, 16′, 16″ has been selected as a carpool host. This message also informs the vehicle owner or operator of the requester pick-up location, the request pick-up time, and the requester drop-off location. This message may be transmitted to the VCP 32 of the vehicle 16, 16′, 16″ associated with the selected carpool candidate CC1 or CC2 for visual representation on the in-vehicle display. The message function may also generate another message (for transmission by the server communication transceiver 58) that is transmitted back to the mobile device communication platform 48 informing the requester 14 that the carpool candidate CC1 or CC2 has been notified of his/her carpool request.

In some instances, the owner or operator may utilize the in-vehicle navigation unit or navigation-related services provided by the center 20 to obtain a route to the requester pick-up location.

Referring back to FIG. 1 specifically, in addition to the carpooling server 18, the center 20 may also include other components, such as a processor 70, switch(es) 72, advisor(s) 74, 74′, database(s) 76, and a network connection or bus 78.

The call center processor 70, which is often used in conjunction with telecommunication and computer equipment (not shown), is generally equipped with suitable software and/or programs enabling the processor 66 to accomplish a variety of center functions. Further, the various operations of the center 20 may be carried out by one or more computers (e.g., computer equipment) programmed to carry out some of the tasks of the center 20. The telecommunication and computer equipment (including computers) may include a network of servers (including carpooling server 18) coupled to both locally stored and remote databases (e.g., database 76) of any information processed.

The center 20 may also include switch(es) 72. The switch 72 may be a private branch exchange (PBX) switch. The switch routes incoming signals so that voice transmissions are usually sent to either a live advisor 74′ or the automated response system 74, and data transmissions are passed on to a modem or other piece of equipment (e.g., a communications module) for demodulation and further signal processing. Carpool requests may be transmitted to the communications module and then routed to the carpooling server 18. The modem preferably includes an encoder, as previously explained, and can be connected to various devices such as the server 18 and database 76.

The center 20 also includes live and/or automated advisors 74′, 74. Each advisor 74′, 74 may be associated with a workstation, including telecommunication and computer equipment.

The database(s) 76 at the center 20 may be designed to store vehicle record(s), subscriber/user profile records, or any other pertinent subscriber and/or vehicle information and/or mobile communications device information. In an example, the database(s) 76 may be configured to store the user profile, which may contain personal information of the subscriber (e.g., the subscriber's name, garage/home address, billing address, home phone number, cellular phone number, etc.), carpooling identification number, etc. It is to be understood that the databases 76 may allow the center 20 to function as a repository for data collected from the vehicle 12. In some instances, another facility may function as a repository for the collected data (e.g., a customer relationship management system (not shown) associated with the center 20 whose database(s) the carpooling server 18 or advisors 74, 74′ can access).

As illustrated in FIG. 1, the various call center components are coupled to one another via a network connection or bus 78 such as one similar to the vehicle bus 36 previously described.

It is to be appreciated that the center 20 may be any central or remote facility, manned or unmanned, mobile or fixed, to or from which it is desirable to exchange voice and data communications. As such, the live advisor 74′ may be physically present at the center 20 or may be located remote from the center 20 while communicating therethrough.

The center 20 shown in FIG. 1 may also be virtualized and configured in a Cloud Computer, that is, in an Internet-based computing environment. For example, the computer equipment 70 may be accessed as a Cloud platform service, or PaaS (Platform as a Service), utilizing Cloud infrastructure rather than hosting computer equipment 70 at the center 20. The database 76 and carpooling server 18 may also be virtualized as a Cloud resource. The Cloud infrastructure, known as IaaS (Infrastructure as a Service), typically utilizes a platform virtualization environment as a service, which may include components such as the processor 70, database 76, carpooling server 18 and other computer equipment. In an example, the real-time carpooling services disclosed herein may be performed in the Cloud via the SaaS (Software as a Service).

In the examples disclosed herein, it is to be understood that once the requester 14 submits the carpool request, he/she cannot submit a second request from the same mobile device 12 until the first carpool request has been fulfilled (i.e., carpool candidate(s) CC are presented to the requester 14 or the no carpool available NCA message is presented to the requester 14).

The examples disclosed herein utilize a set for filters 64, 66, 68 and temporospatial information to identify, from a pool of dynamically narrowed vehicles 16, 16′, 16″, a suitable carpooling vehicle 16, 16′, 16″ for a requester 14. The identification is made within a customizable tolerance of delay for both the driver and the requester 14. Once the graph based street map is generated by the carpooling server 18 (e.g., upon receiving the carpool request), the total time for determining the carpool candidate(s) CC may take 5 minutes or less.

To further illustrate the present disclosure, an example is given herein. It is to be understood that this example is provided for illustrative purposes and is not to be construed as limiting the scope of the present disclosure.

### EXAMPLE

Simulated carpool request results were obtained using an example of the real-time carpooling program disclosed herein. For the simulation, there was a pool of 291 trips, which were collected from vehicles driving within a predefined area at different times of the day. For this example, simulations for 8 different kinds of carpool requests (with different sets of parameters) were performed. A single simulation with the same set of parameters tested 291 requesters, where each trip was considered as a requester at a time, while all of the other trips made up the pool of drivers. As such, the driver inputs for each simulation included data from the pool of drivers. As the requester input, each simulation used bootstrap sampling of one record from the pool of drivers. The driver pool input data included trip travel starting and ending locations within a specified area, and the requester input data included requester pick-up time and location, requester drop-off location. For each simulation, the average speed along the shortest route, the requester's window time δ, and/or the driver's delay time Δ were varied, to determine, in part, the effect the window time and/or the delay time has on the number carpool candidates that were identified.

The real-time carpooling program processed the data for each simulation using the first filter, the second filter, and the third filter disclosed herein. The output of each simulation included the number/percentage of carpools formed (i.e., vehicles that were associated with at least one carpool candidate), which indicated the number/percentage of requesters with one or more carpool candidate found. Some of the parameters and the output are shown for each of the different simulations in the Table below.

In the window time column, the times are shown as [−X, Y]. The −X value is the number of minutes that the requester is willing to be picked up prior to the input pick-up time, and Y is the maximum number of minutes that the requester is willing to be picked up after the input pick-up time. In the delay threshold column, the times are shown as (−∞, Z]. The −∞ value represents that the driver is willing to arrive at the destination any time prior to the originally scheduled end time, is the number of minutes that the requester is willing to be picked up prior to the input pick-up time, and Z is the maximum number of minutes that the driver is willing to arrive at the destination after the originally scheduled end time.

TABLE
SIMULATION RESULTS

| | | | | | # | |
|---|---|---|---|---|---|---|
| | | | | | UNQUALIFIED | |
| SIM./ | AVG. | WINDOW | DELAY | # | TRIPS | % |
| REQUEST | SPEED | TIME | THRESHOLD | CARPOOLS | (NO CARPOOL | CARPOOLS |
| # | (mph) | (minutes) | (minutes) | FORMED | FORMED) | FORMED |
| 1 | 5 | [−5, 1] | (−∞, 5] | 46 | 245 | 15.81 |
| 2 | 10 | [−5, 1] | (−∞, 5] | 58 | 233 | 19.93 |
| 3 | 15 | [−5, 1] | (−∞, 5] | 96 | 195 | 32.99 |
| 4 | 10 | [−5, 2] | (−∞, 5] | 64 | 227 | 21.99 |
| 5 | 10 | [−5, 5] | (−∞, 5] | 72 | 219 | 24.74 |
| 6 | 10 | [−5, 1] | (−∞, 1] | 30 | 261 | 10.31 |
| 7 | 10 | [−5, 1] | (−∞, 10] | 84 | 207 | 28.87 |
| 8 | 10 | [−5, 5] | (−∞, 10] | 126 | 165 | 43.30 |

The simulated results indicate the three filters narrow the pool of active vehicles to suitable carpool candidates. Generally, narrower window times and/or delay thresholds also further narrow the number of carpool candidates (i.e., the carpools formed).

It is to be understood that the term “communication” as used herein is to be construed to include all forms of communication, including direct and indirect communication. Indirect communication may include communication between two components with additional component(s) located therebetween.

Further, the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range. For example, a range from about 5 minutes to about 45 minutes should be interpreted to include the explicitly recited limits of about 5 minutes to about 45 minutes, as well as individual values, such as 5.5 minutes, 15 minutes, 32 minutes, etc., and sub-ranges, such as from about 8 minutes to about 25 minutes, from about 10 minutes to about 40 minutes, etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

While several examples have been described in detail, it will be apparent to those skilled in the art that the disclosed examples may be modified. Therefore, the foregoing description is to be considered non-limiting.

What is claimed is:

1. A real-time carpooling system, comprising:
a mobile device including a microprocessor and a mobile device communication platform;
a participating vehicle including a microprocessor and a vehicle communication platform; and
a carpooling server, including:
a processor;
a server communication transceiver that receives a requester pick-up time and location, a requester drop-off location, and a window time from the mobile device communication platform, and a delay threshold from the vehicle communication platform; and
a real-time carpooling program embedded on a non-transitory, tangible computer readable medium and executable by the processor, the program including:
a first filter including computer readable instructions to identify a qualified trip in response to determining that the requester pick-up time is within a trip travel period of the participating vehicle;
a second filter that receives a then-current location of the participating vehicle associated with the qualified trip, and includes:
computer readable instructions to estimate an arrival time of the participating vehicle at the requester pick-up location; and
computer readable instructions to identify a potential carpool candidate in response to determining that the estimated arrival time is within the window time; and
a third filter, including:
computer readable instructions to estimate a new end time for the potential carpool candidate by combining the then-current location of the participating vehicle with the requester pick-up location, the requester drop-off location, and an original destination of the participating vehicle; and
computer readable instructions to identify a carpool candidate in response to determining that the estimated new end time is within the delay threshold of the participating vehicle.

2. The real-time carpooling system as defined in claim 1 wherein:
the mobile device further includes a display; and
the mobile device communication platform receives the carpool candidate from the server communication transceiver for visual representation on the display.

3. The real-time carpooling system as defined in claim 1 wherein the first filter further includes computer readable instructions to generate a no carpool available message in response to determining that the requester pick-up time is outside the trip travel period of the participating vehicle.

4. The real-time carpooling system as defined in claim 1 wherein the second filter further includes computer readable instructions to generate a no carpool available message in response to determining that the estimated arrival time is outside the window time.

5. The real-time carpooling system as defined in claim 1 wherein the third filter further includes computer readable instructions to generate a no carpool available message in response to determining that the estimated new end time is outside the delay threshold.

6. The real-time carpooling system as defined in claim 1, wherein the program further includes computer readable instructions to determine the trip travel period of the participating vehicle.

7. The real-time carpooling system as defined in claim 1, wherein:
the program further includes a message function responsive to a requester input of a selected carpool candidate received by the server communication transceiver from the mobile device communication platform; and
the message function generates a message for transmission to the selected carpool candidate by the server communication transceiver.

8. The real-time carpooling system as defined in claim 1 wherein the computer readable instructions to estimate the arrival time include computer readable instructions to calculate a shortest travel time by dividing a length of a shortest path from the then-current location of the participating vehicle to the requester pick-up location by an average travel speed along the shortest path.

9. The real-time carpooling system as defined in claim 1 wherein the computer readable instructions to estimate the new end time include computer readable instructions:
to calculate a first shortest travel time by dividing a length of a first shortest path from the then-current location of the participating vehicle to the requester pick-up location by an average travel speed along the first shortest path;
to calculate a second shortest travel time by dividing a length of a second shortest path from the requester pick-up location to the requester drop-off location by an average travel speed along the second shortest path;
to calculate a third shortest travel time by dividing a length of a third shortest path from the requester drop-off location to the original destination of the participating vehicle by an average travel speed along the third shortest path; and
to add the first shortest travel time, the second shortest travel time, and the third shortest travel time to a then-current time.

10. A real-time carpooling system, comprising:
a carpooling server in selective communication with a communication platform of a mobile device and a communication platform of each of a plurality of participating vehicles, the carpooling server including:
a processor;
a real-time carpooling program embedded on a non-transitory, tangible computer readable medium and executable by the processor, the real-time carpooling program including:
a first filter including computer readable instructions to identify n number of qualified carpool trips when a requester pick-up time is within a trip travel period of n number of the participating vehicles, wherein n≧1, and to generate a no carpool available message when the requester pick-up time is outside a trip travel period of all of the n number of the participating vehicles;
a second filter, including:
computer readable instructions to estimate an arrival time for each of the n number of participating vehicles at a requester pick-up location; and
computer readable instructions to identify at least one potential carpool candidate when the estimated arrival time of at least one of the n number of participating vehicles is within a window time of a requester, and to generate the no carpool available message when the estimated arrival time of each of the n number of participating vehicles is outside the window time of the requester;
a third filter, including:
computer readable instructions to estimate a new end time for the at least one potential carpool candidate by combining a then-current location of the at least one of the n number of participating vehicles with the requester pick-up location, a requester drop-off location, and an original destination of the at least one of the n number of participating vehicles; and
computer readable instructions to identify at least one carpool candidate when the estimated new end time is within a delay threshold of the at least one of the n number of participating vehicles, and to generate the no carpool available message when the estimated new end time is outside of the delay threshold of the at least one of the n number of participating vehicles; and
a server communication transceiver to transmit a carpool candidate message to the communication platform of the mobile device or to transmit the no carpool available message to the communication platform of the mobile device.

11. The real-time carpooling system as defined in claim 10, further comprising the mobile device, wherein the mobile device includes:
a display;
a microprocessor; and
a mobile device application executable by the microprocessor, the mobile device application including an output graphical user interface to provide a visual representation of the carpool candidate message on the display or to present the no carpool available message on the display.

12. The real-time carpooling system as defined in claim 11 wherein:
the mobile device application further includes an input graphical user interface to receive the requester pick-up time, the requester pick-up location, the requester drop-off location, and the window time; and
the mobile device further includes a mobile device communication platform to transmit the requester pick-up time and location and the requester drop-off location to the server communication transceiver.

13. The real-time carpooling system as defined in claim 10, wherein the program further includes computer readable instructions to determine the trip travel period of the participating vehicle.

14. A method for making real-time carpool arrangements, the method comprising:
receiving a carpool request including a requested pick-up time and location, a requested drop-off location;
determining whether the requested pick-up time is within a trip travel period of a participating vehicle;
one of: i) identifying a qualified trip when the requested pick-up time is within the trip travel period, or ii) generating a no carpool available message when the requested pick-up time is outside the trip travel period;
when i), then:
determining a then-current location of the participating vehicle associated with the qualified trip;
estimating an arrival time of the participating vehicle at the requested pick-up location;
one of iii) identifying a potential carpool candidate when the estimated arrival time is within a window time of a requester, or iv) generating a no carpool available message when the estimated arrival time is outside the window time of the requester;
when iii), then:
estimating a new end time for the potential carpool candidate by combining the then-current location of the participating vehicle with the requester pick-up location, the requester drop-off location, and an original destination of the participating vehicle;
determining whether the estimated new end time is within a delay threshold of the participating vehicle;
one of v) identifying a carpool candidate when the estimated new end time is within the delay threshold of the participating vehicle, or vi) generating a no carpool available message when the estimated new end time is outside the delay threshold of the participating vehicle; and
when v), then presenting the carpool candidate for selection.

15. The method as defined in claim 14, further comprising receiving the window time from a mobile device of the requester.

16. The method as defined in claim 14, further comprising receiving the delay threshold from the participating vehicle.

17. The method as defined in claim 14, further comprising:
receiving a requester input of a selected carpool candidate; and
transmitting a message to the selected carpool candidate.

18. The method as defined in claim 14 wherein the estimating of the arrival time includes calculating a shortest travel time by dividing a length of a shortest path from the then-current location of the participating vehicle to the requester pick-up location by an average travel speed along the shortest path.

19. The method as defined in claim 14 wherein the estimating of the new end time includes:
calculating a first shortest travel time by dividing a length of a first shortest path from the then-current location of the participating vehicle to the requested pick-up location by an average travel speed along the first shortest path;
calculating a second shortest travel time by dividing a length of a second shortest path from the requested pick-up location to the requested drop-off location by an average travel speed along the second shortest path;
calculating a third shortest travel time by dividing a length of a third shortest path from the requested drop-off location to the original destination of the participating vehicle by an average travel speed along the third shortest path; and
adding the first shortest travel time, the second shortest travel time, and the third shortest travel time to a then-current time.
